(19) United States
(12) Patent Application Publication
(10) Pub. No.: US 2004/0183834 A1
(43) Pub. Date: Sep. 23, 2004

(54) User-configurable soft input applications

(76) Inventor: John C. Chermesino, Orangevale, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/393,418

(22) Filed: Mar. 20, 2003

(51) Int. Cl. G09G 5/00

(52) U.S. Cl. 345/773

(57) ABSTRACT

One embodiment discloses a user-configurable soft input device for a computing device comprising graphical data for displaying visual attributes of the soft input device on a display of the computing device, position data for controlling a position of the soft input device on the display, wherein the position data is editable by a user during runtime, and sizing data for defining a size of the visual attributes of the soft input device, wherein the sizing data is editable by the user during runtime.

### FIELD OF THE INVENTION

The present invention is generally directed to electronic input devices and, is more particularly directed to software implemented input applications.

### DESCRIPTION OF RELATED ART

The advent of touch screen technology laid the foundation for “soft” input devices. Soft input devices, such as keypads, keyboards, and the like, are generally input devices that are implemented in software and are the interface between the computer functionality and typically a touch screen operable by the user. Devices such as information kiosks, industrial controls, building directories, automatic teller machines (ATMs), and the like have previously been implemented using touch screen displays with some embodiment of a software input interface. These interfaces may be configured as a keyboard, a numeric keypad, or some combination of standard keyboards and application specific user interface commands.

Beginning with APPLE™ COMPUTER's NEWTON™ personal data assistant (PDA), touch screen technology was downsized to fit handheld computers. However, initial attempts to implement the user interface for these PDAs was through handwriting recognition software, which until relatively recently, was far from perfect. The next generation of PDA, such as PALM's PALM PILOT™, HEWLETT-PACKARD'S iPAQ™ PDAs (originally offered by COMPAQ), and the like, included not only improved handwriting recognition software, but also included alternative soft keyboards on which users are able to type input using a finger, stylus, or other such tool.

The next step in the evolution of personal computers (PCs) is to combine the power from a typical small-framed computer, such as a notebook or desktop computer, with the convenience of the PDA. One result of the combination is the tablet PC. The concept of a tablet PC comprise generally only a display for interfacing with a user. The display, which could take on a configuration like a paper tablet, not only provides the normal display features of a regular PC, but will also supply the input interface through touch screen technology implementing, among other input means, soft keypads/keyboards or other such input devices that may be operated by users' fingers or styli.

### BRIEF SUMMARY OF THE INVENTION

Embodiments as described herein are directed to a user-configurable soft input device for a computing device comprising graphical data for displaying visual attributes of the soft input device on a display of the computing device, position data for controlling a position of the soft input device on the display, wherein the position data is editable by a user during runtime, and sizing data for defining a size of the visual attributes of the soft input device, wherein the sizing data is editable by the user during runtime.

Additional embodiments are directed to a method for displaying a user-configurable software keyboard comprising positioning the software keyboard on an electronic display at a position defined by a user during runtime, and sizing the software keyboard on the electronic display according to a size defined by the user during runtime.

Further embodiments are directed to a computer program product having a computer readable medium with computer program logic recorded thereon, the computer program product comprising code for positioning the software input device on a computer display using position data entered by a user during runtime, and code for sizing the software input device on the computer display according to size data entered by the user during runtime.

### BRIEF DESCRIPTION OF THE DRAWINGS

FIG. 1 is a diagram illustrating a typical personal data assistant (PDA) configured with a stationary soft keyboard;

FIG. 2 is a diagram illustrating a PDA with a user-configurable software keyboard implemented according to the teachings of representative embodiments of the present invention;

FIG. 3 is a diagram illustrating a tablet PC with a user-configurable soft keypad implemented according to the teaching of additional representative embodiments of the present invention;

FIG. 4A is a diagram illustrating one exemplary embodiment of a user-configurable soft keypad;

FIG. 4B is a diagram illustrating an additional exemplary embodiment of a user-configurable soft keypad;

FIG. 4C is a diagram illustrating another exemplary embodiment of a user-configurable soft keyboard;

FIG. 4D is a diagram illustrating a further exemplary embodiment of a user-configurable soft keypad;

FIG. 5 depicts a block diagram of a computer system which is adapted to use the present invention;

FIG. 6 is a diagram illustrating a tablet PC with a user-configurable soft keypad implemented according to the teaching of further representative embodiments of the present invention; and

FIG. 7 depicts a flowchart of steps according to embodiments described herein.

### DETAILED DESCRIPTION

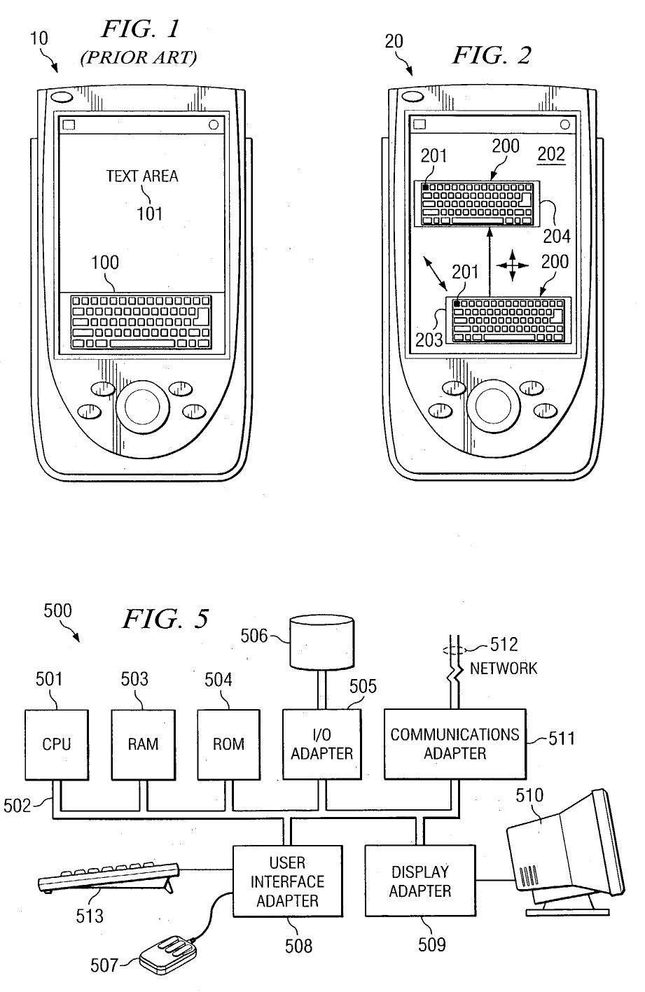

FIG. 1 is a diagram illustrating personal data assistant (PDA) 10 configured with stationary soft keyboard 100. PDA 10 includes text area 101 in which input entered by the user through soft keyboard 100 is displayed. A user must activate the keys in soft keyboard 100. Although the distance between text area 101 and soft keyboard 100 is not very large, even the slight distance can cause eye fatigue as a user must watch the typing and also watch text area 101 for any mistakes in the typing. Furthermore, if the user desires to highlight and/or cut and paste any text from text area 101, the user traverses the distance with a stylus which may also cause hand fatigue.

The problems in the current embodiments of soft keyboards is that the manufacturers have generally created a single, static keyboard configuration for user input. In PDA's, the soft keyboard has typically been placed at the very bottom of the display screen. The early models of tablet PC also have placed the soft keyboard at the foot of the tablet. While these locations are generally acceptable for the majority of users, they do not support visually impaired individuals, or individuals that require different keyboard configurations, or individuals who simply desire to customize their workspace. Furthermore, left-handed individuals may experience difficulties entering information in keyboards situated and configured for the right-handed world.

Keyboard design tools have been created that allow developers to customize soft keyboards, not only by customizing the functionality associated with certain keys, but also by customizing the layout of the keyboard. One such tool, MOUNTFOCUS' KEYBOARD DESIGNER™, allows developers to fully customize soft keyboard layout, functionality, and position. Once created, the new keyboard file and application may then be run on any compatible operating system, such as MICROSOFT WINDOWS™, APPLE COMPUTER's MAC OS™, or the like. The customized keyboard files may also be run in a designated area on the display. However, keyboard design tools are still mostly for software developers. Most users will not be capable of taking advantage of the soft keyboard customization tools and the resulting customized keyboards cannot be manipulated and/or changed during runtime.

FIG. 2 is a diagram illustrating PDA 20 with user-configurable software keyboard 200 implemented according to the teachings of representative embodiments of the present invention. In order to overcome the limitations of the stationary soft keypads, PDA 20 includes user-configurable software keyboard 200 which is rendered with the appropriate graphical data into an independent free-floating window on display 202. By actuating locking key 201, the user can change the visual attributes and appearance by re-sizing and/or moving software keyboard 200 to any part of display 202. Locking key 201 assists by temporarily locking the size and position of software keyboard 200 when the user is working normally. The lock can then be de-activated when the user desires to change software keyboard 200 in any way. It should be noted that locking key 201 is an optional feature on software keyboard 200. Other methods for preventing inadvertent manipulation of software keyboard 200 may be used, such as providing for a double-click on the menu bar in order to release software keyboard 200 for manipulation.

As the user re-sizes software keyboard 200, computer code automatically adjusts the size of the soft keys and the text on the soft keys. Thus, a sight- or manually-impaired individual may increase the size of the soft keys and the text indicators on those keys. The larger keys may be seen more easily by sight-impaired persons and may be easier to manipulate by manually-impaired individuals who may have reduced dexterity or may be required to operate a stylus with their teeth or a partially paralyzed limb. The larger keys may also facilitate easier interaction with those persons wearing gloves in cold, hot, or clean environments. Rendering logic for re-sizing screen objects is well known in the art and has been used in such applications as Web browsers, and the like. Users may also selectively change the size of individual soft keys on software keyboard 200. Thus, the user may determine whether the keys are re-sized proportionally, individually, by group or class (i.e., alpha keys, numeric keys, control keys, and the like). This allows the user to make more common keys more accessible.

In addition to a user changing the size of software keyboard 200, if the user is manipulating or entering text on the upper portion of display 202, he or she may wish to move the entire keyboard from its first position 203, at the bottom of display 202, to position 204 just below the top and to the left side of display 202 by changing the positioning data used to render display 202. By moving software keyboard 200 to position 204, the user decreases the distance for typing and watching the input, and for manipulating data. Also, left-handed users may desire to move the position of software keyboard 200 to better facilitate data entry for those users. Allowing software keyboard 200 to be moved and customized by the user at runtime, the ergonomics of the data entry may be increased. Computer code for re-positioning objects is also well known in the art and has been used in such applications as MICROSOFT WINDOWS™, APPLE COMPUTER's MAC OS™, and other windows-styled applications.

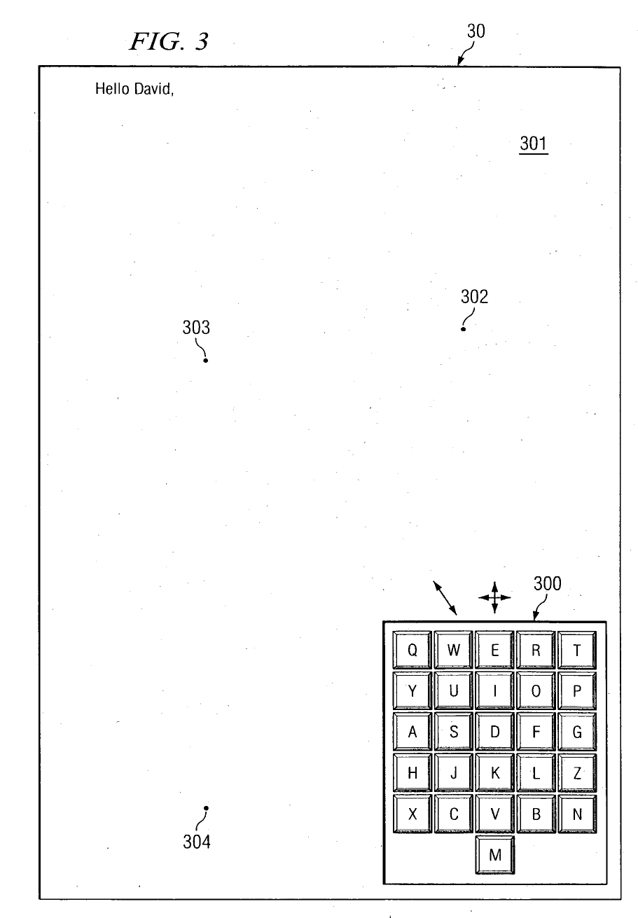

FIG. 3 is a diagram illustrating tablet PC 30 with user-configurable soft keypad 300 implemented according to the teachings of additional representative embodiments of the present invention. Soft keypad 300 demonstrates not only the user-configurable capability for positioning soft keypad 300, but also illustrates the configurability of the key layout. Soft keypad 300 is not configured according to the typical QWERTY keyboard layout. A user may control the layout of the keys in any desired configuration by dragging, placing, or locating the individual key, element, object, or the like to the desired position, thus, changing the configuration data used for displaying soft keypad 300. The user may make these edits during runtime either using drag-and-drop manipulation techniques, “right-clicking” for a drop down menu, or in a separate configuration window that offers the user multiple options for customizing the layout, shape, or color of the keyboard, or the appearance of the key, element, or object through shape, sound, and/or color. The options may also allow the user to assign functions and/or macros to specific, individual keys. In such a manner, the user may completely customize a keyboard by selecting the individual keys and functions for the keyboard.

The distance between display area 301 and soft keypad 300 is much greater than that for a PDA, thus the user may want to move the position of soft keypad 300. For example, the user may desire to drag soft keypad 300 to any of areas 302-304. Depending on how the user intends to input data, he or she may drag soft keypad 300 repeatedly to the several different areas. If the user is entering text at the top of tablet PC 30, the user may drag soft keypad 300 to position 302. If the user must then manipulate text on the right side of display area 301, the user may drag soft keypad to position 303, allowing greater access to the right side of display area 301. Furthermore, if the user enters or manipulates data at the foot of display area 301, the user may drag soft keypad 300 to area 304. Therefore, the user may continually update and change the configuration and/or position of soft keypad 300 during runtime and during any interaction with tablet PC 30. In addition, if the user intends to use a finger to enter data instead of a stylus or pair of styli, the user can re-size soft keypad 300 to make the key size more compatible with his or her finger size.

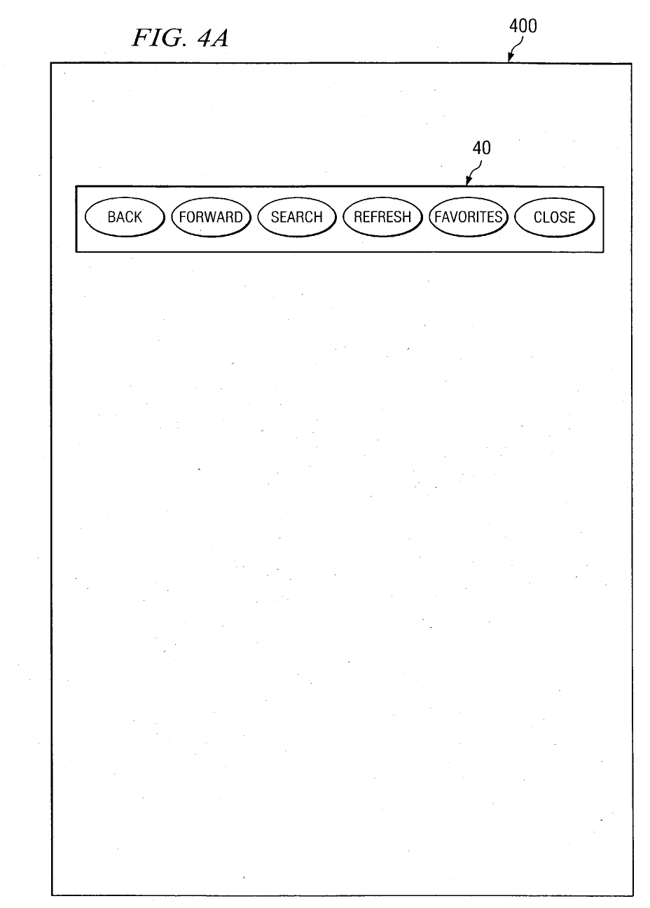

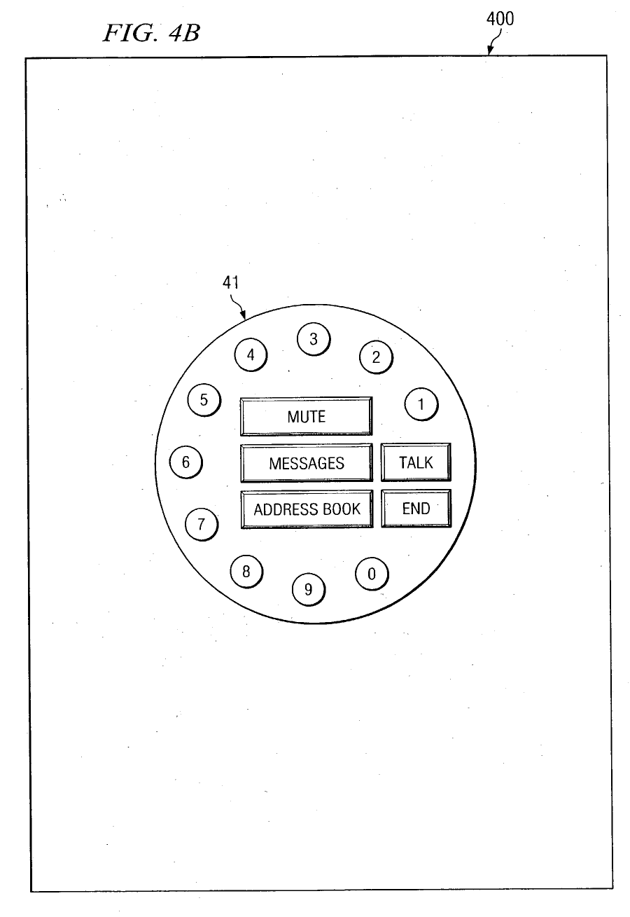

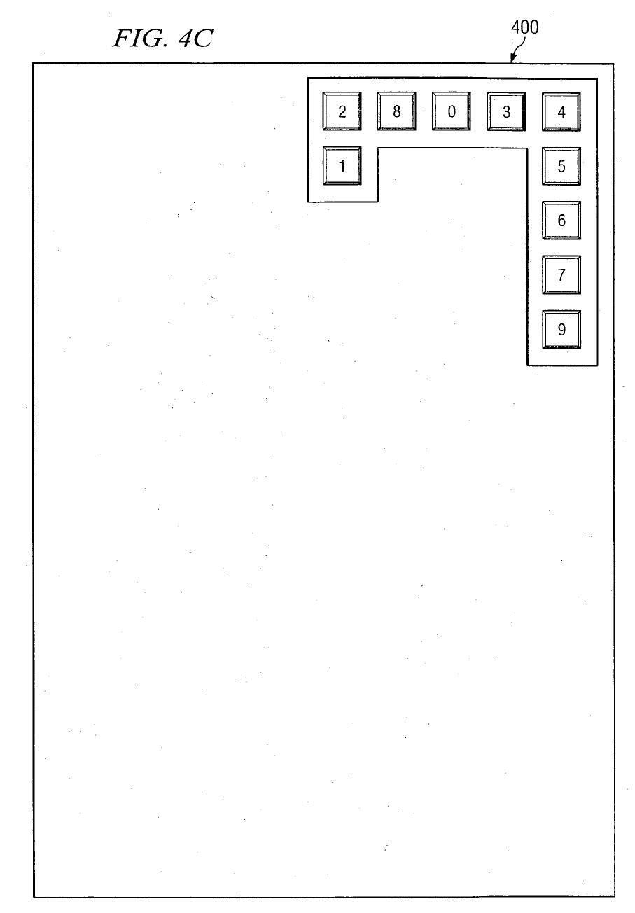

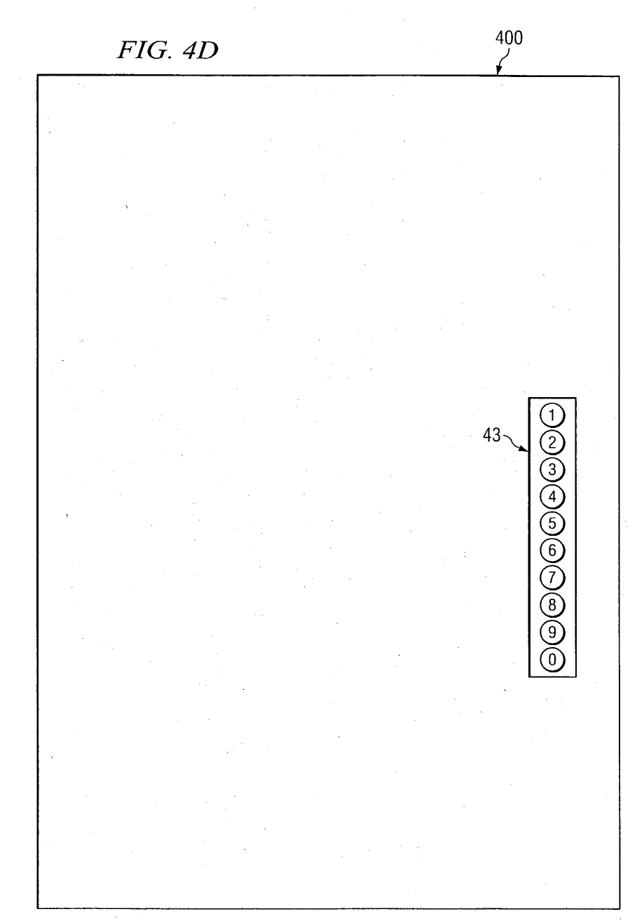

FIGS. 4A-D depicts four different configurations of software keypads and/or keyboards. FIG. 4A is a diagram illustrating one exemplary embodiment of user-configurable soft keypad 40. Keypad 40 has been configured using elliptical buttons and has been positioned by the user toward the upper portion of tablet PC 400. FIG. 4B is a diagram illustrating an additional exemplary embodiment of user-configurable soft keypad 41. Keypad 41 has been configured by the user into a modified version of an old rotary style, telephone dialer situated in the middle of tablet PC 400. FIG. 4C is a diagram illustrating another exemplary embodiment of user-configurable soft keyboard 42. Keypad 42 has been configured by the user in a customized key configuration and positioned at the top right corner of tablet PC 400. Keypad 42 has been configured by the user in a custom sequence. For example, a user may find use for the keys ‘1,’ ‘2,’ ‘8,’ and ‘0’ and, therefore, placed these keys together for easier use. Furthermore, the user may have desired to have the ‘1’ key drop below the ‘2’ key in order to conserve space on tablet PC 400. FIG. 4D is a diagram illustrating a further exemplary embodiment of user-configurable soft keypad 43. Keypad 43 has been configured by the user with circular buttons and positioned at the right side of tablet PC 400. It should be noted that any various configuration may be implemented by the user using the re-sizing and re-positioning capabilities of representative embodiments of the present invention.

When implemented in software, the elements of the present invention are essentially the code segments to perform the necessary tasks. The program or code segments can be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, and the like. The code segments may be downloaded via computer networks such as the Internet, Intranet, and the like.

FIG. 5 illustrates computer system 500 adapted to use the present invention. Central processing unit (CPU) 501 is coupled to system bus 502. The CPU 501 may be any general purpose CPU, such as an INTERNATIONAL BUSINESS MACHINE (IBM) POWERPC™, INTEL™'s PENTIUM™, XSCALE™, or STRONGARM™ processors, or the like. However, the present invention is not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, EEPROM, Flash ROM, or the like. RAM 503 and ROM 504 hold user and system data and programs as is well known in the art.

Bus 502 is also coupled to input/output (I/O) controller card 505, communications adapter card 511, user interface card 508, and display card 509. The I/O adapter card 505 connects to storage devices 506, such as one or more of a hard drive, a CD drive, a floppy disk drive, a tape drive, to the computer system. The I/O adapter 505 would also allow the system to print paper copies of information, such as documents, photographs, articles, etc. Such output may be produced by a printer (e.g. dot matrix, laser, and the like), a fax machine, a copy machine, or the like. Communications card 511 is adapted to couple the computer system 500 to a network 512, which may be one or more of a telephone network, a local (LAN) and/or a wide-area (WAN) network, an Ethernet network, and/or the Internet network. Although the various embodiments of the present invention are applicable with computer systems that use touch screen user input capabilities and do not include typical user input devices, it should be noted that the embodiments described herein are not limited to only computers with such touch screen technology. As such, user interface card 508 may couple user input devices, such as keyboard 513, pointing device 507, and microphone 516, to the computer system 500. The display card 509 is driven by CPU 501 to control the display on display device 510 and may use the graphical data to render the visual attributes of the soft keypad/keyboard onto display device 510.

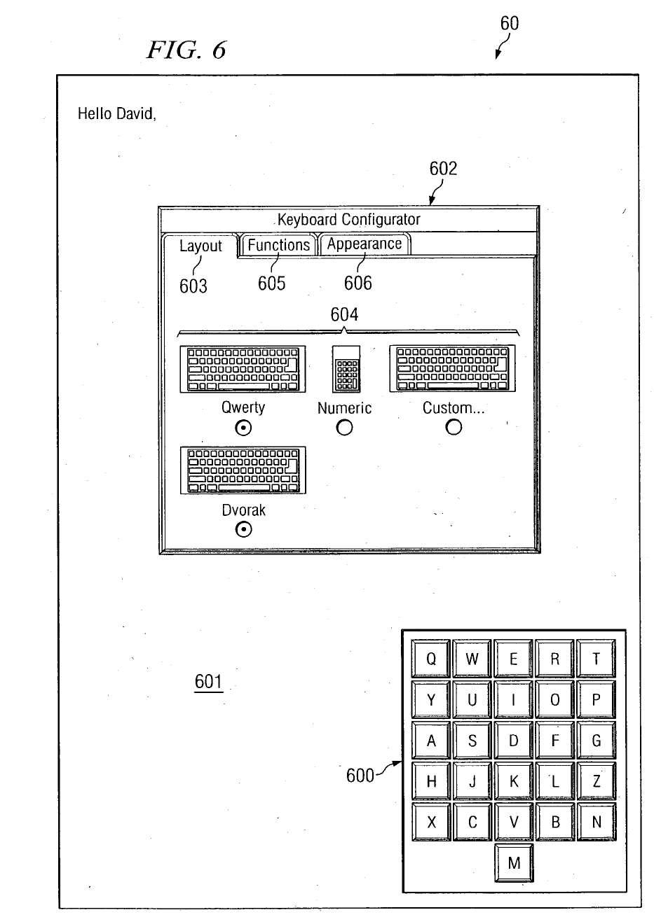

FIG. 6 is a diagram illustrating tablet PC 60:with user-configurable soft keypad 600 implemented according to the teaching of further representative embodiments of the present invention. When a user desires to edit the configuration data to change the layout of soft keypad 600 a selection may be made to display user menu 602. User menu 602 includes several different options available for the user to change configuration information, such as layout screen 603, functions screen 605, and appearance screen 606. In each of user menu 602's screens, options, such as options 604 for selecting a key layout, are presented for the user. Similarly, in functions screen 605, the user is given options to assign functions or macros to selected individual keyboard elements, objects, or buttons. Also, in appearance screen 606, the user may be given options to change the shape of the buttons, the color, and even add sounds. In the described embodiment, once the user finishes the desired configuration edits, user menu 602 may be closed.

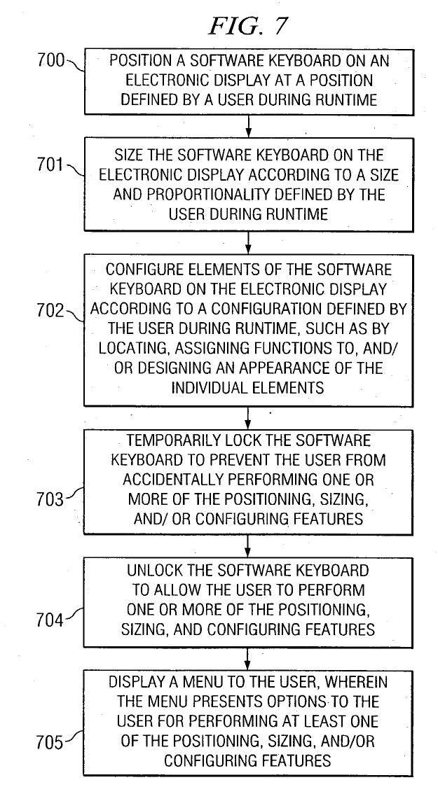

FIG. 7 depicts a flowchart of steps according to embodiments described herein. In step 700, a software keyboard is positioned on an electronic display at a position defined by a user during runtime. In step 701, the software keyboard is sized on the electronic display according to a size and proportionality defined by the user during runtime. The elements of the software keyboard are configured, in step 702, on the electronic display according to a configuration defined by the user during runtime, such as by locating, assigning functions to, and/or designing an appearance of the individual elements. In step 703, the software keyboard may be temporarily locked to prevent the user from accidentally performing one or more of the positioning, sizing, and/or configuring features. The software keyboard may then be unlocked to allow the user to perform one or more of the positioning, sizing, and configuring features in step 704. In step 705, a menu may be displayed to the user, wherein the menu presents options to the user for performing at least one of the positioning, sizing, and/or configuring features.

What is claimed is:

1. A user-configurable soft input device for a computing device comprising:
graphical data for displaying visual attributes of said soft input device on a display of said computing device;
position data for controlling a position of said soft input device on said display, wherein said position data is editable by a user during runtime; and
sizing data for defining a size of said visual attributes of said soft input device, wherein said sizing data is editable by said user during runtime.

2. The user-configurable soft input device of claim 1 further comprising:
configuration data for controlling a layout of said soft input device, wherein said configuration data is editable by said user during runtime.

3. The user-configurable soft input device of claim 2 wherein said layout includes at least one of:
a location of individual keys comprising said soft input device;
a function associated with said individual keys; and
an appearance of said individual keys.

4. The user-configurable soft input device of claim 3 wherein said appearance of said individual keys includes:
a color;
a shape; and
a sound.

5. The user-configurable soft input device of claim 2 further comprising:
a user menu operable by said user for editing one or more of:
said position data;
said size data; and
said configuration data.

6. The user-configurable soft input device of claim 1 further comprising:
rendering logic for automatically re-sizing said visual attributes of said soft input device responsive to edits made by said user, wherein said rendering logic changes said graphical data according to said edits.

7. The user-configurable soft input device of claim 1 further comprising:
a locking key operable by said user for temporarily locking said position of said soft input device.

8. The user-configurable soft input device of claim 7 wherein said locking key further temporarily locks said size of said soft input device.

9. The user-configurable soft input device of claim 8 wherein said user deactivates said locking key by depressing said locking key.

10. A method for displaying a user-configurable software keyboard comprising:
positioning said software keyboard on an electronic display at a position defined by a user during runtime; and
sizing said software keyboard on said electronic display according to a size defined by said user during runtime.

11. The method of claim 10 further comprising:
configuring elements of said software keyboard on said electronic display according to a configuration defined by said user during runtime.

12. The method of claim 11 wherein said configuring includes:
locating individual elements according to input from said user;
assigning functions to said individual elements according to said input from said user; and
designing an appearance of said individual elements according to input from said user.

13. The method of claim 11 further comprising:
locking said software keyboard to prevent said user from performing one or more of:
said positioning;
said sizing; and
said configuring.

14. The method of claim 13 further comprising:
unlocking said software keyboard to allow said user to perform one or more of:
said positioning;
said sizing; and
said configuring.

15. The method of claim 11 further comprising:
displaying a menu to said user, wherein said menu presents options to said user for at least one of:
said positioning;
said sizing; and
said configuring.

16. The method of claim 10 wherein said sizing comprises proportional sizing.

17. A computer program product having a computer readable medium with computer program logic recorded thereon, said computer program product comprising:
code for positioning said software input device on a computer display using position data entered by a user during runtime; and
code for sizing said software input device on said computer display according to size data entered by said user during runtime.

18. The computer program product of claim 17 further comprising:
code for configuring objects of said software input device on said computer display according to configuration data entered by said user during runtime.

19. The computer program product of claim 18 wherein said configuring includes:
code for placing individual objects according to input from said user;
code for associating functions to said individual objects according to said input from said user; and
code for designing an appearance of said individual objects according to input from said user.

20. The computer program product of claim 18 further comprising:
code selectable by said user for temporarily deactivating execution of one or more of:
said code for positioning;
said code for sizing; and
said code for configuring.

21. The computer program product of claim 18 further comprising:
code for displaying a menu to said user, wherein said menu presents options for said user to enter data for executing at least one of:
said code for positioning;
said code for sizing; and
said code for configuring.
